(19) United States
(12) Patent Application Publication
(10) Pub. No.: US 2024/0398053 A1
(43) Pub. Date: Dec. 5, 2024

(54) Adjustable Headbands

(71) Applicant: Apple Inc., Cupertino, CA (US)

(72) Inventors: Ryan M David, San Francisco, CA (US); Benjamin A Shaffer, San Jose, CA (US); Benjamin A Stevenson, Oakland, CA (US); Evan A Cernokus, Campbell, CA (US); Robert V Tang, San Francisco, CA (US); Dustin A Hatfield, Campbell, CA (US); Erin M Bosch, San Jose, CA (US); Yuhao Pan, Sunnyvale, CA (US); Venkata Narayana Murthy Arelekatti, Mountain View, CA (US); Katherine E Christensen, Shoreline, WA (US); Paul J Biestek, Kenmore, WA (US); Alexander Siegel, Hayward, CA (US); Megan Grant, San Francisco, CA (US); Zachary M Hammond, Mountain View, CA (US); Lindsey J Scenna, Santa Clara, CA (US); Alyssa B Abood, Emerald Hills, CA (US); Thanh T Tran, Sunnyvale, CA (US); Zilan Chen, Shenzhen (CN); Michael Wu, San Jose, CA (US)

(21) Appl. No.: 18/639,878

(22) Filed: Apr. 18, 2024

Related U.S. Application Data
(60) Provisional application No. 63/627,432, filed on Jan. 31, 2024.
(60) Provisional application No. 63/505,653, filed on Jun. 1, 2023.

(51) Int. Cl. A41D 20/00; G06F 1/16

(52) U.S. Cl. CPC A41D 20/00; G06F 1/163

(57) ABSTRACT

A head-mounted device may have a head-mounted housing containing rear-facing displays that display images for a user when the head-mounted housing is worn by the user. The head-mounted housing may be coupled to the user's head using a headband. The headband may include a first headband portion and a second headband portion that extends from the first headband portion at a fixed angle. Stiffeners may be included in the first and second headband portions. The stiffeners may be formed from braided cords and may be embedded in the first and second headband portions to allow the headband to conform to a user's head when worn. Other stiffeners may be mounted to a surface of the headband to maintain an angle between the first and second headband portions. The ends of the headband may have curved corners, and may appear seamless to the naked eye.

This application claims the benefit of U.S. provisional patent application No. 63/627,432, filed Jan. 31, 2024, and U.S. provisional patent application No. 63/505,653, filed Jun. 1, 2023, which are hereby incorporated by reference herein in their entireties.

### FIELD

This relates generally to headbands, and, more particularly, to adjustable headbands for electronic devices.

### BACKGROUND

Electronic devices such as head-mounted devices may have displays for displaying images. The displays may be housed in a head-mounted support structure.

### SUMMARY

A head-mounted device may have a head-mounted housing containing rear-facing displays that display images for a user when the head-mounted housing is worn by the user. The head-mounted housing may be coupled to the user's head using a headband.

The headband may include a first headband portion and a second headband portion that extends from the first headband portion at a fixed angle. Alternatively, the headband may pass through a ring and/or a carrier, and the ring and/or carrier may separate the first and second portions. As another alternative, the first headband portion and/or the second headband portion may be coupled to one or more pivots, and a distance between the first and second headband portions may be adjusted by rotating the first and/or second headband portions about the pivot(s). Stiffeners may be included in the first and second headband portions.

The stiffeners may be formed from braided cords and may be embedded in the first and second headband portions to allow the headband to conform to a user's head when worn. The stiffeners may run along edges of the first and second housing portions, such as a lower edge of the first headband portion and an upper edge of the second headband portion.

Other stiffeners may be mounted to a surface of the headband to maintain an angle between the first and second headband portions when worn by a user.

The headband may include a woven fabric portion surrounded by a webbing. The webbing may have rounded corners at an edge of the woven fabric portion, and the webbing may appear seamless to the naked eye.

One or more keeper loops may be incorporated into the headband. The keeper loops may be coupled to multiple portions of the headband and may maintain the position of the portions of the headband relative to one another.

### BRIEF DESCRIPTION OF THE DRAWINGS

FIG. 1 is a side view of an illustrative electronic device such as a head-mounted display device with an adjustable headband in accordance with some embodiments.

FIGS. 2A and 2B are side views of opposing sides of an illustrative headband in accordance with some embodiments.

FIG. 3 is an illustrative front view of an edge of a headband in accordance with some embodiments.

FIG. 4 is a side view of an illustrative headband with a seam that is invisible to a naked eye in accordance with some embodiments.

FIG. 5A is a side view of an illustrative headband having stiffeners on a surface of the headband separated into two headband portions by a planar ring in accordance with some embodiments.

FIG. 5B is a side view of an illustrative headband having stiffeners on a surface of the headband separated into two headband portions by a curved ring in accordance with some embodiments.

FIGS. 6A-6C are side views of illustrative stiffeners that may be incorporated onto a surface of a headband in accordance with some embodiments.

FIG. 7 is a side view of an illustrative headband having embedded stiffeners in accordance with some embodiments.

FIG. 8 is a perspective view of an illustrative stiffener in a channel of a headband in accordance with some embodiments.

FIGS. 9A and 9B are side views of illustrative headbands with local stiffeners that change the curvature of the headband when under tension in accordance with some embodiments.

FIG. 10 is a side view of an illustrative headband that includes a keeper loop to maintain the position of portions of the headband in accordance with some embodiments.

FIG. 11 is a perspective view of an illustrative headband that includes a keeper loop to maintain the position of portions of the headband in accordance with some embodiments.

FIG. 12 is a side view of an illustrative headband that includes a keeper loop and an integrated adjuster loop in accordance with some embodiments.

FIG. 13 is a side view of an illustrative headband separated into two headband portions by a carrier in accordance with some embodiments.

FIGS. 14A-14C are side views of illustrative carriers in accordance with some embodiments.

FIG. 15 is a side view of an illustrative headband separated having two headband portions coupled to one or more pivots in accordance with some embodiments.

FIGS. 16A-16E are side views of illustrative carriers with pivot points in varied locations and orientations in accordance with some embodiments.

### DETAILED DESCRIPTION

Head-mounted devices include head-mounted support structures that allow the devices to be worn on the heads of users. The head-mounted support structures may include device housings for housing components such as displays that are used for presenting a user with visual content. The head-mounted support structures for a head-mounted device may also include headbands and other structures that help hold a device housing on the face of a user. The headband of a head-mounted device may be adjustable.

In some embodiments, it may be desirable to incorporate a bifurcated headband that contacts the user's head in multiple locations while the head-mounted device is worn. The headband may include different woven textures on opposite sides of the headband (e.g., on the side in contact with the user's head vs. facing away from the user's head), and may include hair-safe hook and loop fasteners. The headband may have ends with seamless curved webbings. To prevent the headband from slipping with respect to the user's head, stiffeners and/or cords may be included on and/or in the headband. If cords are included in the headband, the headband may have adaptive curvature based on the location of the cords within the headband. As a result, the headband may conform to the user's head.

A keeper loop may be incorporated between different portions of a headband to allow for adjustment of the headband and for maintaining the position of the portions of the headband relative to each other.

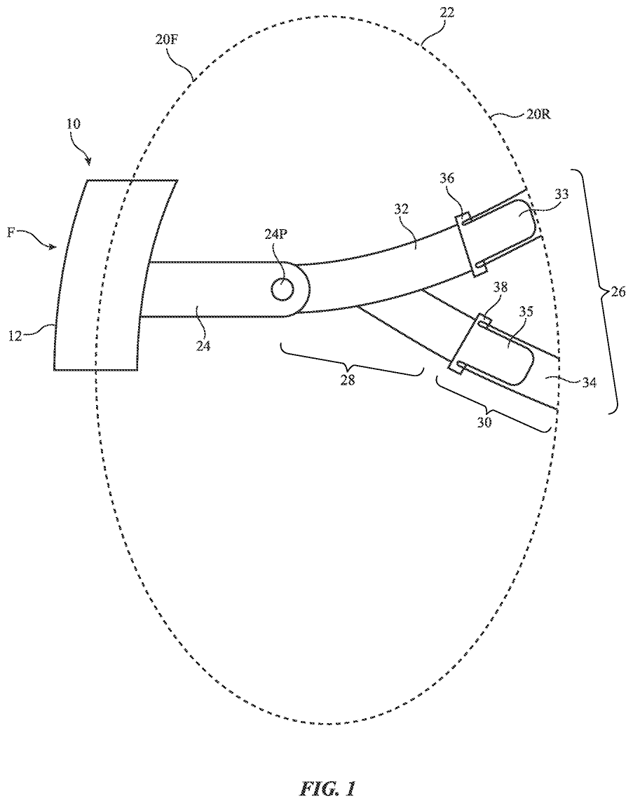

FIG. 1 is a side view of an illustrative head-mounted electronic device with an adjustable headband. As shown in FIG. 1, head-mounted device 10 may include head-mounted housing 12 (sometimes referred to as a main housing, main housing unit, head-mounted support structure, etc.). Housing 12 may have walls or other structures that separate an interior housing region from an exterior region surrounding housing 12. For example, housing 12 may have walls formed from polymer, glass, metal, and/or other materials. Electrical and optical components may be mounted in housing 12. These components may include components such as integrated circuits, sensors, control circuitry, input-output devices, etc.

To present a user with images for viewing from eye boxes (e.g., eye boxes in which the user's eyes are located when device 10 is being worn on the users' head such as head 22 of FIG. 1), device 10 may include displays and lenses. These components may be mounted in optical modules or other supporting structure in housing 12 to form respective left and right optical systems. There may be, for example, a left display for presenting an image through a left lens to a user's left eye in a left eye box and a right display for presenting an image to a user's right eye in a right eye box.

If desired, housing 12 may have forward-facing components such as cameras, other sensors, and/or a display on front F for gathering sensor measurements/other input and/or display information on front F. Housing 12 and may have a soft cushion on an opposing rear side of housing 12. The rear of housing 12 may have openings that allow the user to view images from the left and right optical systems (e.g., when the rear of housing 12 is resting on front surface 20F of the user's head 22.

Device 10 may have an adjustable strap such as adjustable headband 26 and, if desired, may have other structures (e.g., an optional over-the-head strap) to help hold housing 12 on head 22. Headband 26 may have first and second ends coupled, respectively, to the left and right sides of housing 12. In the example of FIG. 1, coupling members 24, which serve as extensions of housing 12 (e.g., extend from housing 12 directly or are attached directly to housing 12), are provided on the left and right sides of housing 12. Members 24 may be formed from rigid materials such as rigid polymer and/or other materials and may contain sensors, buttons, speakers, and other electrical components. Hinges and/or other mechanisms may be used to couple members 24 to housing 12 or members 24 may be formed as integral portions of a main housing unit. The ends of headband 26 may have coupling mechanisms such as openings configured to receive posts or other protrusions 24P on members 24 or other housing structures. These coupling mechanisms allow a user to removably attach headband 26 to members 24 and thereby removable attach headband 26 to housing 12. Members 24 may have elongated shapes of the type shown in FIG. 1 and/or other suitable shapes and may sometimes be referred to as rigid straps, rigid coupling members, or power straps.

Headband 26 may have a soft flexible portion such as central portion 30. Central portion 30 may be formed between two stiffer portions such as end portions 28 on the left and right ends of headband 26. End portions 28 may be stiffened using embedded polymer stiffeners (e.g., single-layer or multilayer polymer stiffening strips) and/or other stiffening members.

Central portion 30 may be formed from a stretchable material such as stretchy fabric. Central portion 30 may, as an example, be formed from a band of flat knit fabric that includes stretchable strands of material (e.g., elastomeric strands) and/or which uses a stretchable fabric construction (e.g., a stretchable knit construction). Alternatively, central portion 30 may be formed from a band of woven fabric, which may include stretchable strands of material and/or may use a stretchable fabric construction. Narrowed end portions of the band of knit fabric may, if desired, extend over stiffening members in end portions 28 (e.g., to ensure that headband 26 has a uniform external appearance).

Central portion 30 may include two bifurcated headband portions 32 and 34. In particular, bifurcated headband portions 32 and 34 may form two portions of the same headband 26 (e.g., headband portions 32 and 34 may be connected to the same points in end portions 28). In the illustrative embodiment of FIG. 1, portion 32 may be attached to protrusions 24P, and portion 34 may extend from portion 32 at a fixed angle. In other embodiments, headband portions 32 and 34 may both be attached to protrusions 24P, thereby being able to pivot about protrusions 24P individually.

Headband portions 32 and 34 may both contact rear portions of head 22. In particular, headband portion 32 may contact an upper rear portion of head 22 (e.g., in the upper half of the rear of head 22), while headband portion 34 may contact a lower rear portion of head 22 (e.g., in the lower half of the rear of head 22). By contacting the rear of head 22 in two different locations, headband portions 32 and 34 may secure device 10 to head 22 while mitigating the amount of stress applied to any portion of head 22.

The stretchability of central portion 30 (and therefore headband portions 32 and 34 of headband 26) allows headband 26 be stretched along its length. This allows the length of headband 26 to be temporarily increased to help a user place headband 26 over the user's head when a user is donning device 10. When headband 26 is released, the stretchiness and elastic nature of central portion 30 of headband 26 will help shorten headband 26 and pull headband 26 against the user's head so that headband 26 rests against rear surface 20R the user's head.

Further adjustment of the tension of headband 26 to secure headband 26 and device 10 on the user's head may be provided by tightening doubled-back portions 33 and 35 of headband 26. In particular, doubled-back portions 33 and 35 may pass through adjustment loops 36 and 38, respectively. Doubled-back portions 33 and 35 may have hook-and-loop fasteners on an inner surface, allowing doubled-back portions 33 and 35 to be secured to headband portions 32 and 34. In this way, headband portions 32 and 34 may be tightened or loosened as desired by a user of device 10.

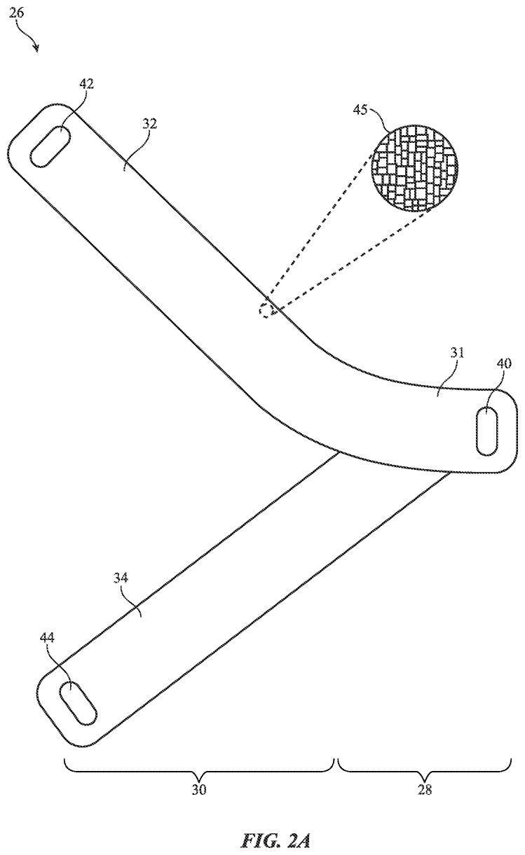

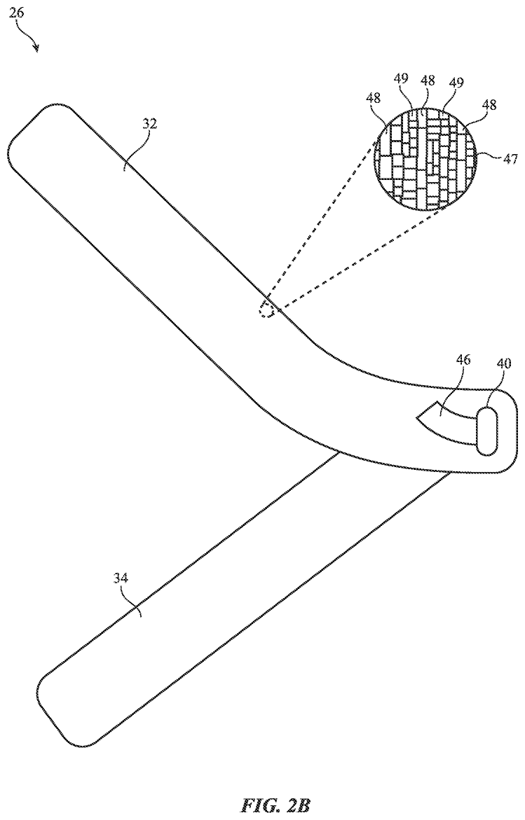

FIG. 2A is an illustrative side view of an outer surface (e.g., the surface that faces away from head 22 when worn) of headband 26 in a configuration in which headband 26 is not attached to housing 12. As shown in FIG. 2A, headband 26 may have a stretchable central portion 30 that includes portions 32 and 34 formed from stretchy woven or knit fabric and may have end portions 28 (e.g., end portions that are stiffened using stiffeners embedded in the fabric) one of end portions 28 is shown in the side view of FIG. 2A. One or more openings 40 may be formed in the ends of headband 26 in portion 31. Openings 40 may receive posts or other protrusions such as protrusion 24P of FIG. 1 to secure the left and right ends of headband 26 to the left and right members 24 of device 10. There may be a single opening 40 or other attachment mechanism located on each end of headband 26 or each end of headband 26 may have two or more openings 40. If desired, other attachment mechanism (e.g., magnets, snaps, latches, hook-and-loop fasteners, screws or other fasteners, etc.) may be used in attaching headband 26 to members 24 or other portions of the housing of device 10.

As shown in FIG. 2A, portions 32 and 34 of headband 26 may both extend from portion 31 of headband 26. In other words, portions 32 and 34 may extend from portion 31 at a fixed angle to one another. Portion 31 may be more rigid (e.g., less stretchy) than portions 32 and 34, if desired. For example, portion 31 may include one or more rigid or semi-rigid layers, such as polymer layers or metal layers.

By coupling (e.g., weaving, knitting, or otherwise intertwining) portions 32 and 34 with portion 31, portions 32 and 34 may be kept at a constant angle with respect to one another. In other words, portions 32 and 34 may remain separated by a fixed angle when worn on head 22.

Headband portions 32 and 34 may respectively include hook-and-loop fasteners 42 and 44, which may secure the ends of portions 32 and 34 when the end portions are doubled back to tighten headband 26 (as shown in FIG. 1). Hook-and-loop fasteners 42 may be, for example, hair-safe hook-and-loop fasteners that prevent hair from being caught in fasteners 42.

The outer surface of headband 26 may be woven. As shown in FIG. 2A, on the outer side of headband 26, headband 26 may have solid loop weave 45. Solid loop weave 45 may be tightly woven and have a uniform appearance across headband 26. The loops in solid loop weave 45 may provide the loops for hook-and-loop fasteners 42.

FIG. 2B is an illustrative side view of an inner surface (e.g., the surface in contact with head 22 when worn) of headband 26 in a configuration in which headband 26 is not attached to housing 12.

Headband 26 may have a tab, such as tab 46. Tab 46 may be attached to a latch (or other suitable attachment mechanism) in opening 40 that attaches headband 26 to post 24P (also referred to as protrusion 24P herein). By pulling on tab 46, a user may release the latch from post 24P, and headband 26 may be removed from member 24. However, this attachment mechanism of headband 26 to member 24 is merely illustrative. In general, headband 26 may attach to member 24 in any suitable manner.

The inner surface of headband 26 may be woven. As shown in FIG. 2B, on the inner side of headband 26, headband 26 may have ribbed loop weave 47. Ribbed loop weave 47 may provide sufficient friction for headband 26 to remain in place on head 22, while being comfortable on head 22 (e.g., on a user's hair). Ribbed loop weave 47 may include loops 49 and rib portions 48. By having ribbed loop weave 47, the inner surface of headband 26 may have less tightly-packed loops than solid loop weave 45 on the outer surface of headband 26, thereby improving the user's comfort.

Although FIGS. 2A and 2B show headband 26 as being woven, this is merely illustrative. In general, headband 26 may be formed from fabric including strands that are intertwined using knitting, weaving, braiding, and/or other strand intertwining techniques.

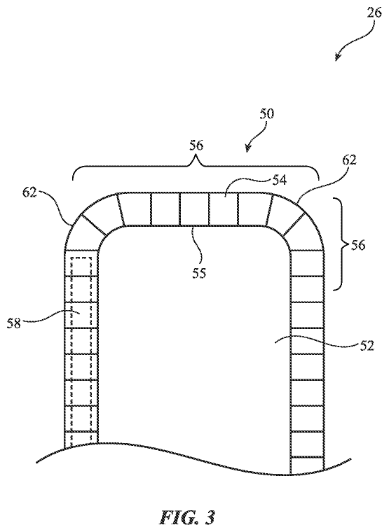

In some embodiments, it may be desirable to create a curved edge that appears seamless at the end of headband 26. An illustrative headband strap with a curved edge with a seam that is invisible to the naked eye is shown in FIG. 3.

As shown in FIG. 3, strap 50 may be formed from inner woven portion 52 and webbing 54. In particular, webbing 54 may be sewn, woven, or otherwise coupled to woven portion 52. Woven portion 52 may have a solid loop weave (e.g., solid loop weave 45 of FIG. 2A) or a ribbed loop weave (e.g., ribbed loop weave 47 of FIG. 2B), as examples.

Although portion 52 has been described as being woven, this is merely illustrative. In general, portion 52 may be knitted, woven, braided, and/or formed using other strand intertwining techniques.

Webbing 54 may have portion 56 that wraps from one side of inner woven portion 52 (e.g., the left side of inner woven portion 52), across edge 55 of strap 50, to the opposite side of inner woven portion 52 (e.g., the right side of inner woven portion 52).

A stiffener may be inserted into webbing 54, if desired. In the illustrative example of FIG. 3, stiffener 58 may be inserted into webbing 54, such as one side of webbing 54. In particular, webbing 54 may have multiple layers, and stiffener 58 may be inserted between the multiple layers. Alternatively, webbing 54 may be formed as a single piece using a flat knitting technique and includes a built-in channel (sometimes referred to as a pocket or cavity), and stiffener 58 may be inserted into the built-in channel. In general, however, stiffener 58 may be inserted into webbing 54 in any desired manner.

Stiffener 58 may be formed from a cord, such as a braided cord, or a flexible strip of polymer (e.g., an elastomer such as thermoplastic polyurethane). Stiffener 58 may be sufficiently flexible to permit the headband to bend and twist, but may not stretch substantially along its length and may therefore sometimes be referred to as a non-stretchable stiffener, non-stretchable member, non-stretchable stiffening structure, etc. Stiffener 58 may significantly less stretchy and soft than the fabric of strap 50 and may serve to increase the stiffness and decrease (or eliminate) stretchiness at desired portions along strap 50. At the same time, the flexibility of stiffener 58 may allow strap 50 to bend around the curvature of a user's head. Stiffener 58 may be inserted into selected portions of strap 50 to selectively stiffen strap 50 at desired portions along its length, if desired.

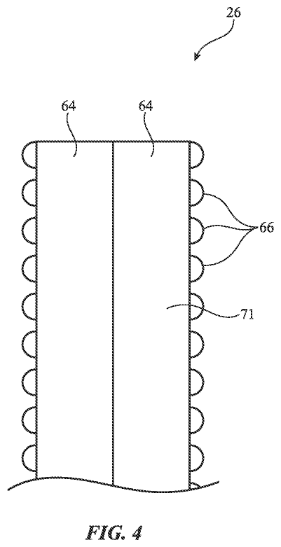

Headband 26 may have rounded corners 62 of webbing 54 and may not have visible seams. An illustrative side view of headband 26 is shown in FIG. 4.

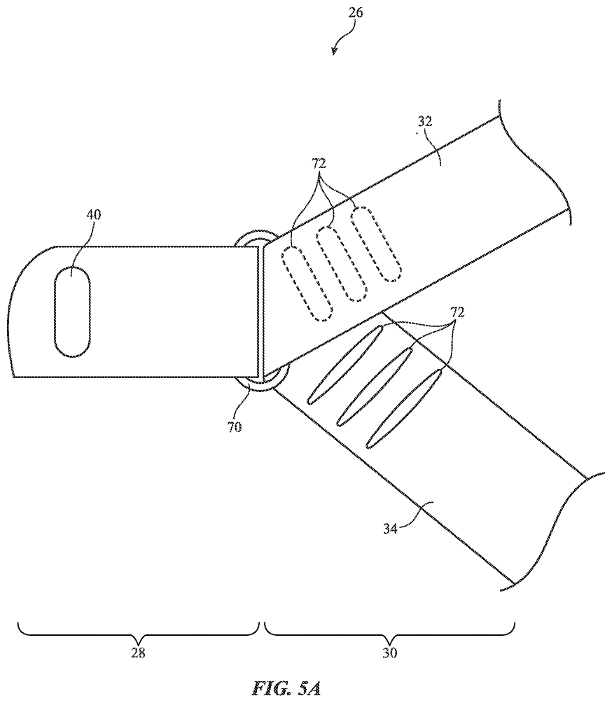

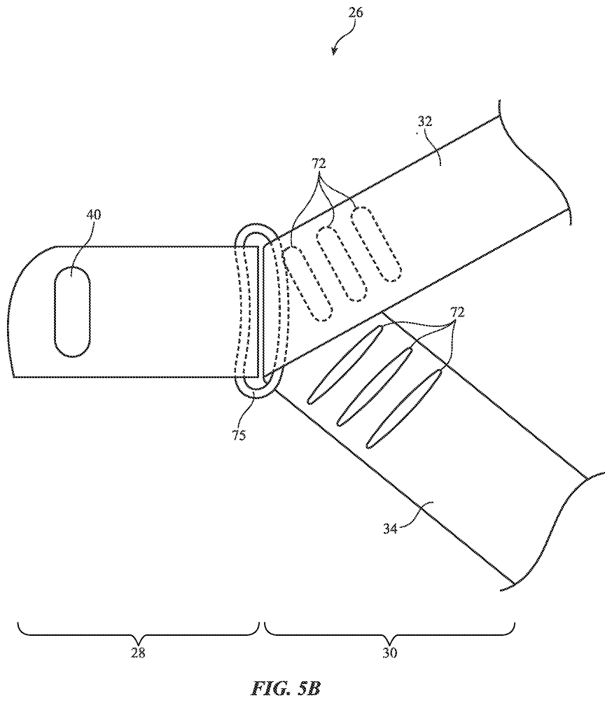

As shown in FIG. 4, headband 26 may include layers 64 and loops 66 (e.g., in webbing 54 of FIG. 3). Webbing from one side of headband 26 (e.g., portion 56 of FIG. 3) may be bonded to the other side of the webbing at point 71 (e.g., headband 26 may have single seam at point 71 one only one side of headband 26). As shown in FIG. 5A, there may be no visible seam at point 71. In this way, a one-sided seam that is not visible to the naked eye may be formed in headband 26.

Although FIGS. 2A and 2B show portions 32 and 34 of headband 26 extending from a common portion 31, this is merely illustrative. If general, portions 32 and 34 may be coupled and attached to a head-mounted device in any suitable manner, such as attaching portions 32 and 34 separately to a common post or wrapping a single band through a ring to double back on itself. An illustrative embodiment of a single band wrapped through a ring is shown in FIG. 5A.

As shown in FIG. 5A, headband 26 may be wrapped through ring 70 to form portions 32 and 34. Ring 70 may be a metal ring, a rigid polymer ring, or a ring of other suitable material. To ensure that portions 32 and 34 remain at a desired angle with respect to one another when worn by a user, stiffeners 72 may be added to headband 26. Stiffeners 72 may be formed from rigid polymer, metal, or other suitable material.

Stiffeners 72 may locally increase the stiffness of headband 26 in the area around ring 70. As a result, portions 32 and 34 may maintain the angle between each other about ring 70 when headband 26 is worn on a user's head. Moreover, stiffeners 72 may create detents to provide a user of headband 26 with feedback regarding how tight headband 26 is on the user's head. In other words, because stiffeners 72 have to pass through ring 70 when a user tightens or loosens headband 26, stiffeners 72 may indicate to the user how tight the headband is (e.g., by how may stiffeners the user feels pass through ring 70).

Although ring 70 is shown in FIG. 5A as having straight (planar) edges, this is merely illustrative. If desired, a ring in headband 26 may be a curved ring. An illustrative example is shown in FIG. 5B.

As shown in FIG. 5B, headband 26 may be wrapped through curved ring 75 to form portions 32 and 34. Curved ring 75 may help maintain the separation between portions 32 and 34. For example, when portions 32 and 34 are as close as possible, a ring with straight edges, such as ring 70 of FIG. 5B, may allow portions 32 and 34 to overlap, while curved ring 75 may maintain a minimum of at least 5 mm, at least 10 mm, between 5 mm and 25 mm, or other suitable distance between portions 32 and 34.

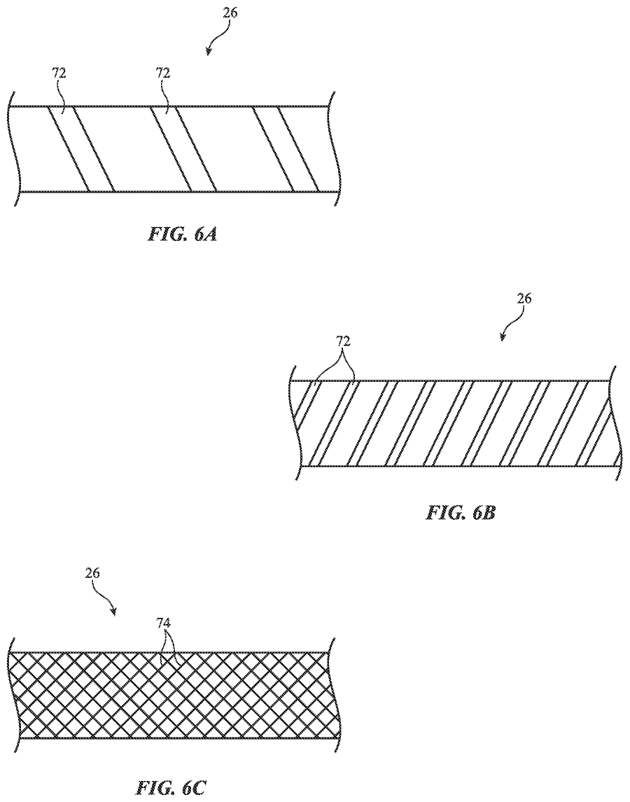

The stiffeners shown in FIGS. 5A and 5B are merely illustrative. In general, stiffeners may be added to headband 26 in any suitable manner. For example, as shown in illustrative FIGS. 6A and 6B, stiffeners 72 may be added with different sizes, pitches, and/or geometries to adjust the stiffness of headband 26 about ring 70. Stiffeners 72 may be proud of the surface of headband 26, or may be formed flush or sub-flush with the surface of headband 26. As another illustrative example, as shown in FIG. 6C, cuts 74 may be made in headband 26. Cuts 74 may selectively modify the stiffness of headband 26 in different regions, and cuts 74 may be made so that headband 26 has more stiffness in the region adjacent to ring 70 than in other regions. In general, stiffeners in headband 26 may have any suitable geometries and may help maintain the angle between portions 32 and 34 about ring 70.

Although stiffeners 72 are shown in FIGS. 5A and 5B as being used when headband 26 extends through ring 70, this is merely illustrative. Stiffeners 72 may be included on a surface of headband 26 if the portions of headband 26 are in a fixed position (as shown in FIG. 1, as an example).

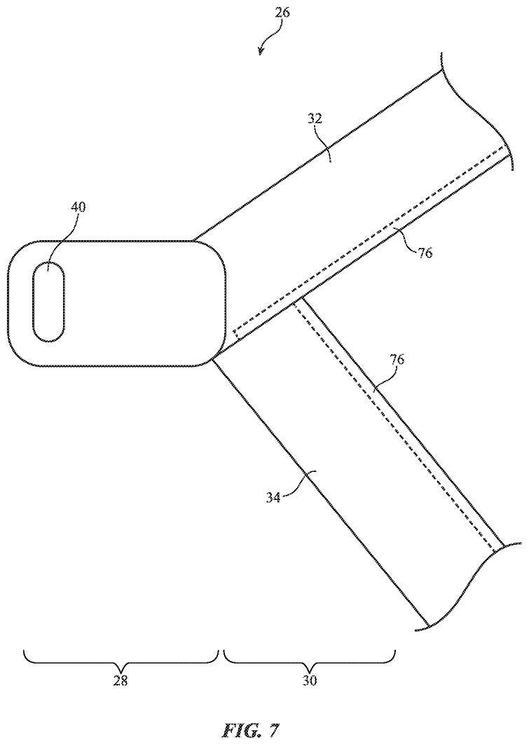

In addition to, or instead of, stiffeners 72, headband 26 may be have stiffeners that run along a length of headband 26. An illustrative example of a headband with stiffeners of this type is shown in FIG. 7.

As shown in FIG. 7, portions 32 and 34 of headband 26 may include stiffeners 76. Stiffeners 76 may be the same as stiffener 58 of FIG. 3, as an example. Stiffeners 76 may be formed from a cord, such as a braided cord, or a flexible strip of polymer (e.g., an elastomer such as thermoplastic polyurethane). Stiffeners 76 may be more rigid (e.g., less flexible/stretchy) than the other portions of headband 26.

Stiffeners 76 may be inserted along one side of portions 32 and 34, as shown in FIG. 7. In particular, because stiffeners 76 stretch less than the rest of portions 32 and 34, portions 32 and 34 may conform to a user's head (e.g., head 22 of FIG. 1) and support the head-mounted device against the user's face more effectively.

Stiffeners 76 may extend entirely along the lengths of portions 32 and 34, or may extend across parts of the lengths of portions 32 and 34. In general, stiffeners 76 may be coupled to suitable parts of portions 32 and 34 to adjust the stiffness of portions 32 and 34 across their length as needed.

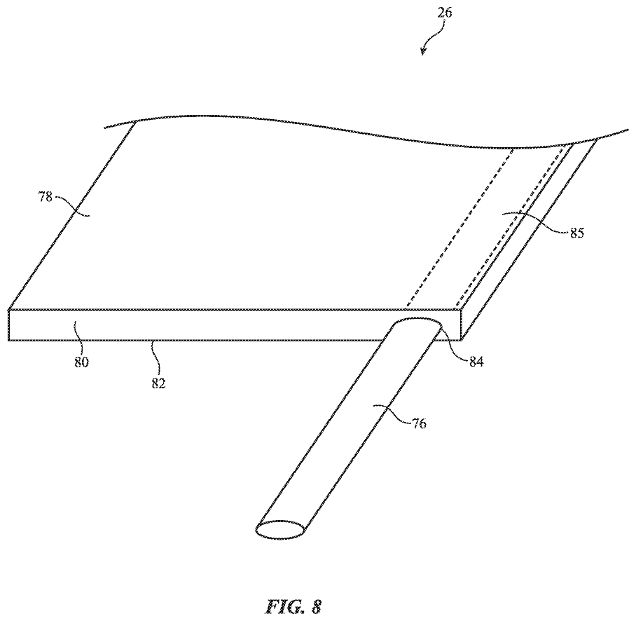

Stiffeners 76 may be inserted into channels within headband 26. As shown in illustrative FIG. 8, headband 26 may include strap 78 (which may correspond to strap 50 of FIG. 3) having surfaces 80 and 82. Between surfaces 80 and 82, strap 78 may have channel 85 with opening 84 at an edge of strap 78. Stiffener 76 may be mounted within channel 85. In other words, stiffener 76 may be embedded within strap 78 (e.g., within headband 26).

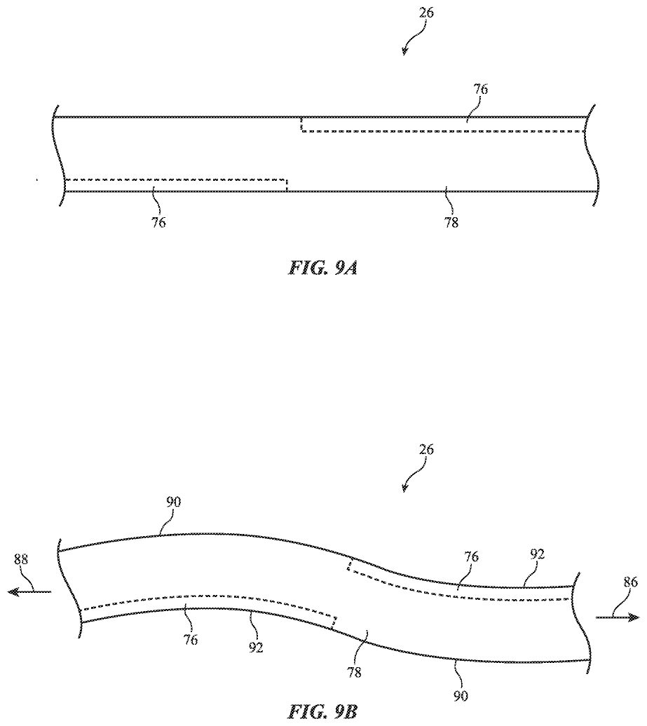

Stiffeners 76 may adjust the stiffness and curvature of headband 26. In particular, by adding stiffeners 76 to different regions of headband 26, headband 26 may curve differently in different regions. An illustrative example of a headband having stiffeners in different regions to create regions with different curvatures is shown in FIGS. 9A and 9B.

As shown in FIG. 9A, headband 26 may be straight when not under tension. In other words, when headband 26 is not on a user's head or otherwise under tension, headband 26 may return to a straight configuration. However, when headband 26 is pulled in opposite directions, headband may curve differently based on the locations of stiffeners 76.

As shown in FIG. 9B, portions 90 of headband 26 may curve more than portions 92 in response to headband 26 being pulled in directions 88 and 86. In particular, because stiffeners 76 are formed in portions 92, portions 92 may be stiffer than portions 90, which do not have stiffeners 76 (in other words, stiffeners 76 are stiffer than the fabric of strap 78). As a result, in response to pulling both ends of headband 26 in directions 88 and 86, headband 26 may extend in a serpentine pattern.

In some embodiments, headband 26 may be straight when not under tension (e.g., FIG. 9A) an may bend to conform to compound curvature (e.g., a user's head) when under tension (e.g., FIG. 9B). However, this is merely illustrative. In general, stiffeners 76 may be included in any suitable portion of headband 26 so that headband 26 bends as desired when under tension.

Returning to FIG. 7, by forming stiffener 76 on the bottom edge of portion 32 and stiffener 76 on the upper edge of portion 34, headband 26 may conform to a user's head when worn by the user. In other words, headband 26 may sit flat against the user's head across different curvatures of the head (e.g., headband 26 may distribute pressure evenly across a non-uniform surface). However, this is merely illustrative. If desired, stiffeners 76 may be formed on the upper edge of portion 32 or on the lower edge of portion 34, depending on the shape to which headband 26 needs to conform.

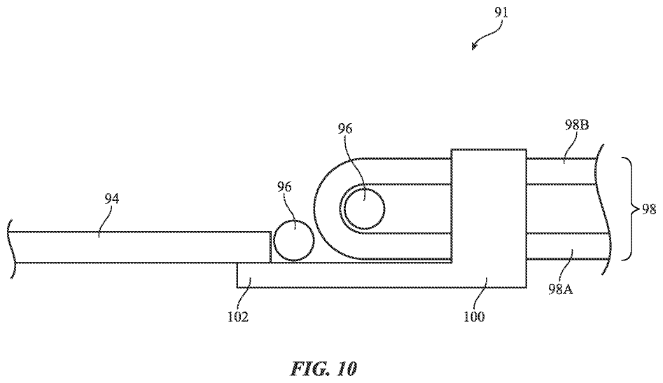

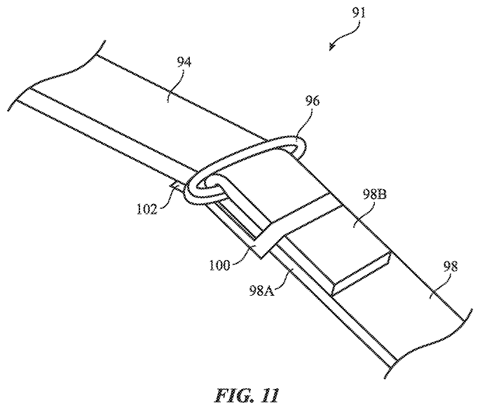

In some embodiments, a keeper loop may be incorporated between portions of a headband to allow for the headband to be adjusted, while maintaining the positions of the portions of the headband relative to one another. An illustrative example of a headband with a keeper loop is shown in FIG. 10.

As shown in FIG. 10, headband 91 (which may correspond with headband 26 of FIG. 2), may have headband portions 94 and 98 (which may correspond with headband portions 32 and 34 of FIG. 2, or any other suitable portion of headband 26). In general, however, headband portions 94 and 98 may correspond with any desired portions of a headband.

Adjuster loop 96 (which may correspond with adjustment loop 36 or 38 of FIG. 1, for example) may be coupled to headband portion 94. For example, headband portion 94 may be adhesively coupled to adjuster loop 96, may be tied around adjuster loop 96, may be received within a cavity of adjuster loop 96, or otherwise may be attached to adjuster loop 96.

Headband portion 98 may have first portion 98A and second portion 98B separated by a portion of adjuster loop 96. In other words, second portion 98B may double back on first portion 98A after passing through adjuster loop 96. By adjusting the amount of headband portion 98 that passes through adjuster loop 96, the size of headband 91 may be adjusted.

Keeper loop 100 may be included in headband 91 to maintain the position of headband portions 94, 98A, and 98B. Keeper loop 100 may be formed from reinforced fabric. For example, keeper loop 100 may be reinforced with one or more polyethylene terephthalate (PET) layers or other polymer layers, one or more fiberglass layers, one or more adhesive layers, and/or one or more fabric layers. These layers may then be covered by a fabric, such as a webbing.

Keeper loop 100 may have portion 102 attached to headband portion 94, such as using an adhesive. Alternatively, portion 102 may be woven or otherwise attached to headband portion 94. By attaching portion 102 of keeper loop 100 to headband portion 94, keeper loop 100 may maintain its position relative to headband portion 94, preventing keeper loop 100 from sliding down headband portion 98.

Although FIG. 10 shows keeper loop 100 attached headband portion 94 directly, keeper loop 100 may be attached to (e.g., tucked into an opening of) adjuster loop 96, if desired.

First and second portions 98A and 98B of headband portion 98 may pass through keeper loop 100. Keeper loop 100 may keep headband portion 98 flat and minimize the bend radius between portions 98A and 98B, allowing headband 91 to have a low profile. In particular, the position of keeper loop 100 relative to adjuster loop 96 may minimize this bend radius.

As shown in FIG. 10, adjuster loop 96 may be oriented at an angle relative to the plane of headband portion 94, such as with an angle of at least 20°, at least 30°, or at least 40°, as examples. By orienting adjuster loop 96 in this way, portion 98A of headband portion 98 may be aligned with headband portion 94 (e.g., the plane of portion 98A may be coplanar with the plane of headband portion 94). Aligning portion 98A with headband portion 94 may allow for headband 91 to be more comfortable when worn, allow for casier adjustments of headband 91, and/or prevent adjuster loop 96 from contacting the user's head.

Keeper loop 100 may maintain the curvature of headband 91 when headband 91 is not being worn. In particular, because keeper loop 100 is attached to headband portion 94 and to headband portion 98, the shape of headband portion 92 may be maintained when it is not on a user's head. Similarly, because keeper loop 100 contacts both sides of the headband, keeper loop 100 may prevent the headband from becoming disconnected if it is not properly fastened.

When headband 91 is worn, keeper loop 100 may separate adjuster loop 96 from the user's head. Additionally or alternatively, the friction between keeper loop 100 and headband portion 98 may prevent headband portion 98 from moving relative to adjuster loop 96.

Although FIG. 10 shows portions 98A and 98B passing through a common opening of keeper loop 100, this is merely illustrative. Keeper loop 100 may have two openings, with portions 98A and 98B each passing through one of the openings, if desired. For example, fabric, which may be reinforced with PET, fiberglass, and/or other material, may separate the two openings.

An illustrative perspective view of headband 91 with keeper loop 100 is shown in FIG. 11. As shown in FIG. 11, the use of keeper loop 100 may maintain a small bend radius between portions 98A and 98B of headband portion 98 as it passes through adjuster loop 96.

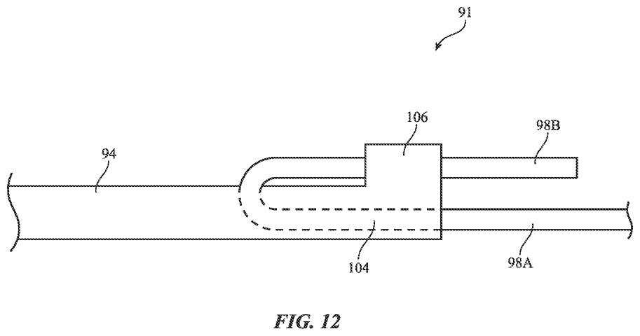

In some embodiments, adjuster loop 96 may be omitted. An illustrative example of a headband without an adjuster loop is shown in FIG. 12.

As shown in FIG. 12, headband portion 94 of headband 91 may include cavity 104 and integral keeper loop 106. Keeper loop 106 may be formed from the same materials as keeper loop 100 (FIG. 10). For example, the fabric layer(s) of keeper loop 106 may be woven or otherwise attached to the fabric of headband portion 94.

Portion 98A of headband portion 98 may pass through cavity 104 before doubling back as headband portion 98B through keeper loop 106. In this way, an adjuster loop may be omitted from headband 91, and headband portion 98 may still have a low profile due to keeper loop 106.

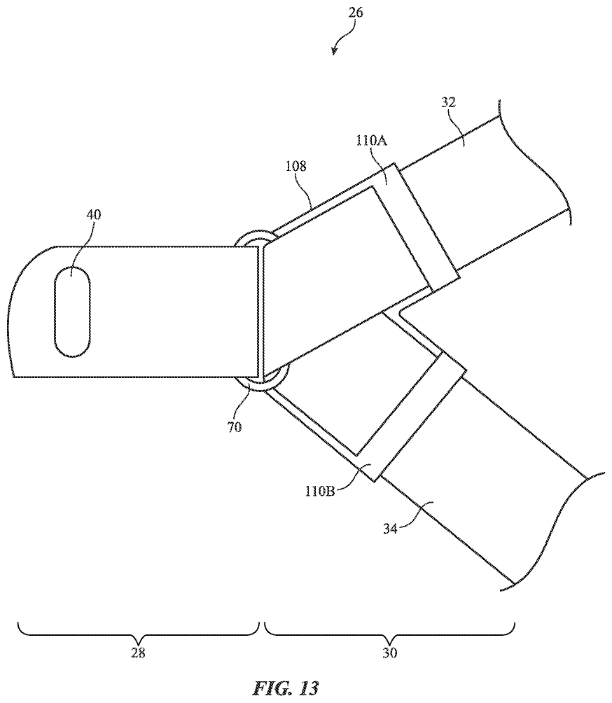

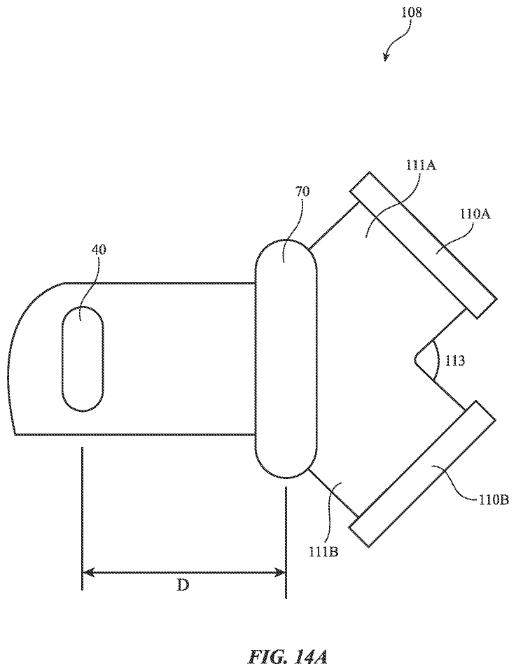

Although headband 26 has been described as having portions 32 and 34 separated by a ring (e.g., as in FIGS. 5A and 5B), this is merely illustrative. In some embodiments, a carrier with multiple openings may be used to separate portions of a headband. An illustrative example is shown in FIG. 13.

As shown in FIG. 13, carrier 108 may include ring 70 and may separate portion 32 and portion 34. Carrier 108 may be a soft carrier and may be formed from fabric, polymer, or other suitable material.

Carrier 108 may include loop 110A through which portion 32 passes and loop 110B through which portion 34 passes. The use of carrier 108 with loops 110A and 110B may maintain the separation between portions 32 and 34. Additionally, if carrier 108 is formed form a soft and/or flexible material, carrier 108 may be comfortable against the head of a user of headband 26.

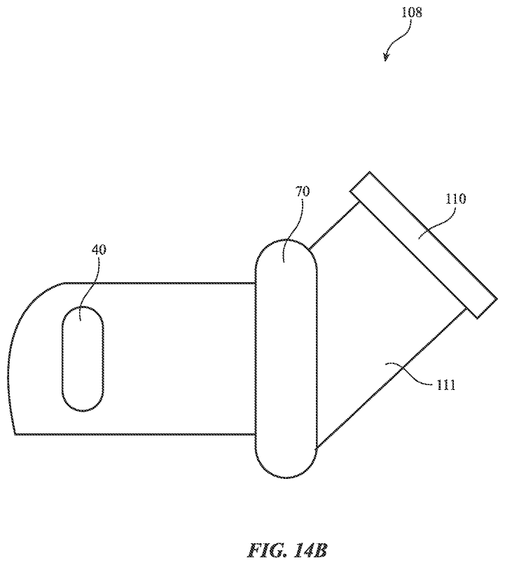

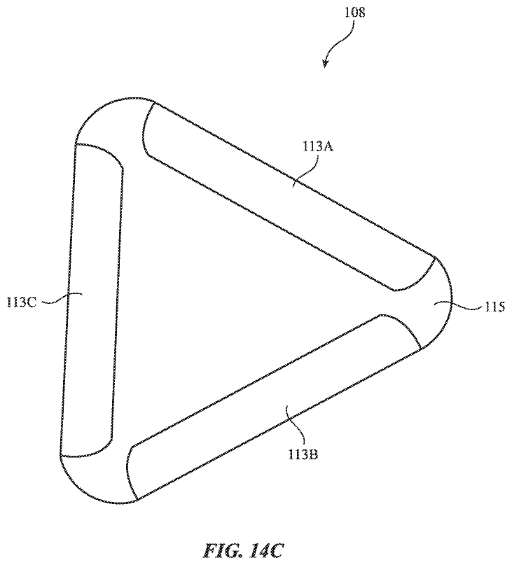

Although carrier 108 is shown as having ring 70 and two loops 110A and 110B, this is merely illustrative. In some embodiments, carrier 108 may include three loops or two loops. Illustrative examples are shown in FIGS. 14A-14C.

As shown in FIG. 14A, carrier 108 may include opening 40 (e.g., for attaching headband 26 to portion 31—see FIG. 2A), ring 70, and loops 110A and 110B. As shown in FIG. 13, headband 26 may pass through ring 70, loop 110A, and loop 110B to separate portion 32 from portion 34.

Carrier 108 may have angle 113 between arm portions 111A and 111B that end with loops 110A and 110B. In other words, carrier 108 may maintain angle 113 between portions 32 and 34 (FIG. 13) when headband 26 passes through carrier 108. Angle 113 may be 35°, 45°, at least 30°, between 25° and 65°, or other suitable angle. In this way, carrier 108 may maintain a gap between portions 32 and 34 of headband 26.

Ring 70 may be separated from opening 40 by distance D. Distance D may allow a headband (e.g., headband 26) that passes through carrier 108 to sit further back on a user's head, avoiding the user's ears. Distance D may be at least 15 mm, at least 25 mm, between 15 mm and 45 mm, 20 mm, at least 30 mm, or other suitable distance.

Although FIG. 14A shows carrier 108 with two arm portions 111, this is merely illustrative. As shown in illustrative FIG. 14B, for example, carrier 108 may have single arm portion 111 and single loop 110. Similar to FIGS. 13 and 14A, a headband (e.g., headband 26) may pass through ring 70 and loop 110 to separate portion 32 from portion 34.

In other embodiments, as shown in illustrative FIG. 14C, carrier 108 may have triangular body 115, which may be formed from fabric, polymer, or another flexible material. Openings 113A, 113B, and 113C may be formed in body 115. A headband, such as headband 26, may pass through openings 113A, 113B, and 113C to separate portion 32 from portion 34. Alternatively, individual headband portions may each be coupled to openings 113A, 113B, and 113C, which may maintain separation between the individual headband portions.

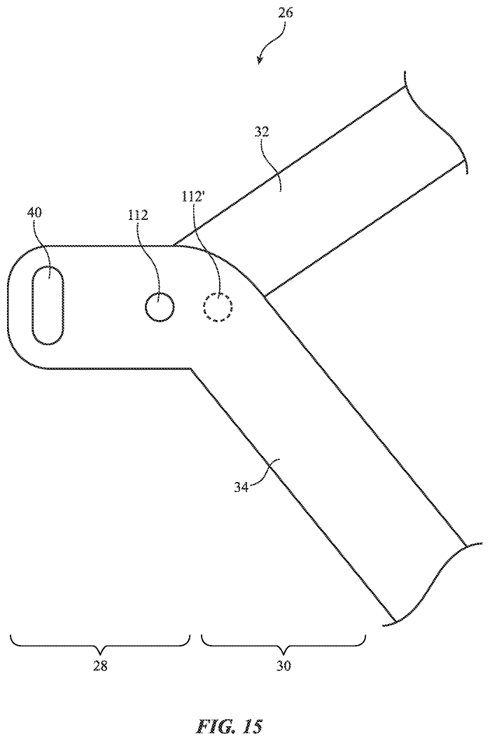

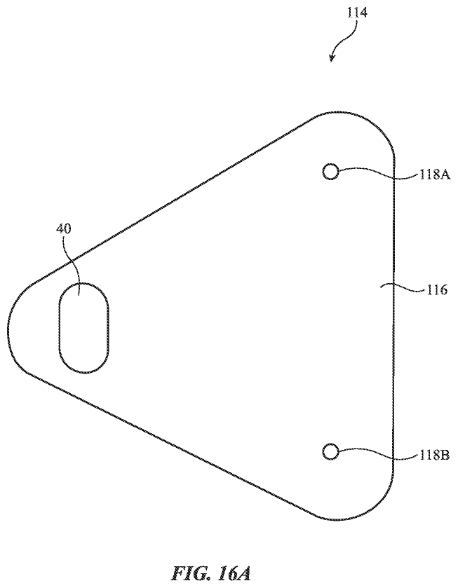

FIGS. 13 and 14 have shown and described using carrier 108 to separate portions of a headband. However, the use of a carrier is merely illustrative. In some embodiments, a pivot may be used to separate portions of a headband, and the headband portions may be moved relative to one another. An illustrative example is shown in FIG. 15.

As shown in FIG. 15, headband 26 may include pivot 112. Portion 32 and/or portion 34 may be attached to pivot 112. The portion(s) of headband 26 attached to pivot 112 may be moved relative to the other portion of headband 26. In this way, the position of portion 32 and/or portion 34 may be adjusted.

Portions 32 and 34 may be attached to the same pivot 112, or may be attached to different pivots 112. For example, portion 32 may be attached to pivot 112, while portion 34 may be attached to pivot 112′. However, this is merely illustrative. In general, portion 32 and/or portion 34 may be attached to any suitable pivot(s), and a distance between portion 32 and portion 34 may be adjusted by rotating portion 32 and/or portion 34 around the pivot(s).

Portion 32 and/or portion 34 may be attached to one or more pivots one side of headband 26 (e.g., on one side of the user's head when headband 26 is worn) or may be attached to one or more pivots on both sides of headband 26 (e.g., on both sides of the user's head when headband 26 is worn).

One or more pivots may have an adjustable location. For example, portion 32 and/or portion 34 may be attached to pivot 112, and pivot 112 may be moved between a first location (e.g., the location of pivot 112 in FIG. 15) and a second location (e.g., the location of pivot 112′ in FIG. 15), such as by detaching portion 32 and/or portion 34 from one pivot and reattaching them to another pivot, or by moving the pivot itself within a channel. In this way, the location of the pivot may be adjusted to adjust the fitment of headband 26.

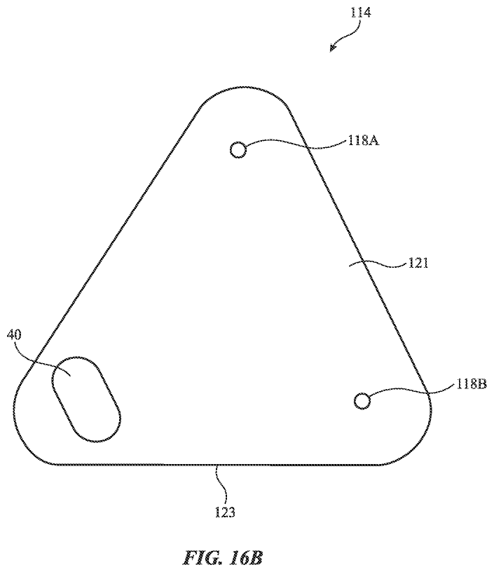

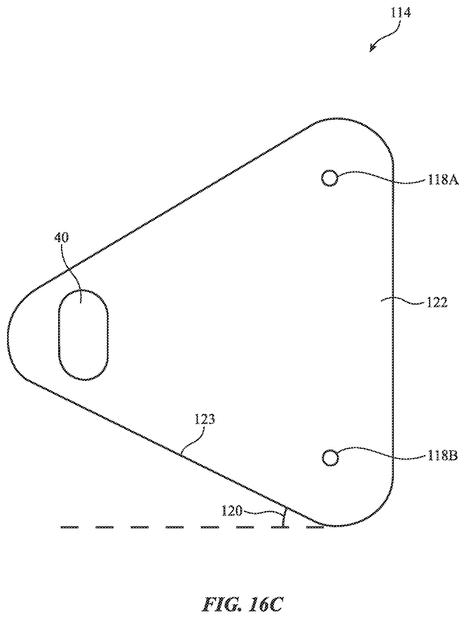

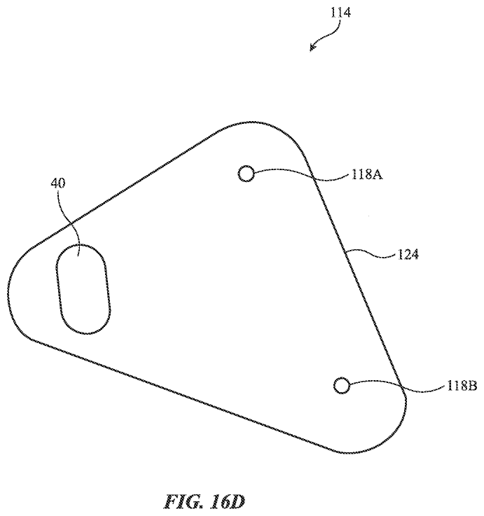

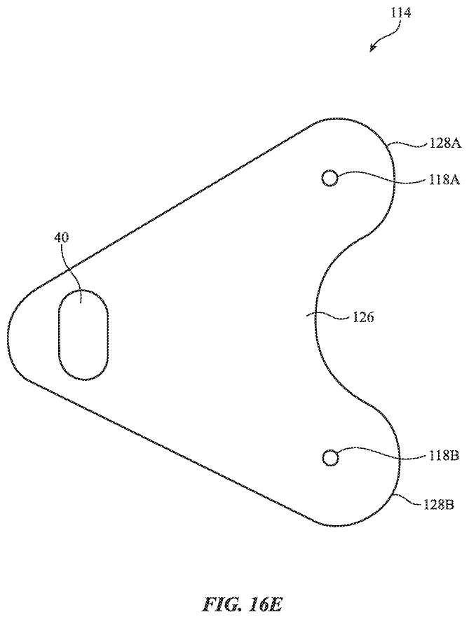

Illustrative pivot locations are shown in FIGS. 16A-16E. For example, carrier 114 may include body 116 formed from fabric, polymer, metal, or other suitable material. Carrier 114 may have opening 40 (e.g., for attaching headband 26 to portion 31—see FIG. 2A).

In the example of FIG. 16A, body 116 may be triangular, and may have pivot points 118A and 118B. Pivot points 118A and 118B may be aligned vertically. In some embodiments, a first portion of a headband (e.g., portion 32 of headband 26) may be attached to pivot point 118A, and a second portion of a headband (e.g., portion 34 of headband 26) may be attached to pivot point 118B. Pivot points 118A and 118B may be separated from opening 40 by any suitable distance, such as by at least 20 mm, by at least 25 mm, by 26 mm, or by between 25 mm and 30 mm, as examples.

In some embodiments, it may be desirable to offset pivot points 118A and 118B horizontally (e.g., so they are not aligned along a vertical line). In the illustrative example of FIG. 16B, pivot points 118A and 118B may be offset, such as by at least 5 mm, at least 10 mm, by between 5 mm and 20 mm, or other suitable distance. Carrier 114 may have triangular body 121 with horizontal lower edge 123 to accommodate the offset between pivot points 118A and 118B. However, this is merely illustrative. In general, carrier 114 may have offset pivot points with a body having any suitable shape. For example, in the illustrative example of FIG. 16C, carrier 114 may have body 122 with lower edge 123 that is offset from the horizontal by angle 120. Angle 120 may be at least 12°, at least 10°, 12.5°, between 10° and 20°, or other suitable angle.

In some embodiments, the distance between pivot points may be increased. As shown in the illustrative example of FIG. 16D, carrier 114 may include body 124 with an elongated triangular shape. Here, pivot points 118A and 118B may be separated by at least 15 mm, at least 20 mm, between 10 mm and 25 mm, or other suitable distance.

Although FIGS. 16A-16D show carrier 114 having a body with a triangular shape, this is merely illustrative. In general, carrier 114 may have any suitable shape to separate portions of a headband that are coupled to carrier 114. For example, in the illustrative example of FIG. 16E, carrier 114 may have body 126 having curved protrusions 128A and 128B. Pivots 118A and 118B may be formed within protrusions 128A and 128B.

As described above, one aspect of the present technology is the gathering and use of information such as information from input-output devices. The present disclosure contemplates that in some instances, data may be gathered that includes personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, username, password, biometric information, or any other identifying or personal information.

The present disclosure recognizes that the use of such personal information, in the present technology, can be used to the benefit of users. For example, the personal information data can be used to deliver targeted content that is of greater interest to the user. Accordingly, use of such personal information data enables users to have control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (HIPAA), whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide certain types of user data. In yet another example, users can select to limit the length of time user-specific data is maintained. In addition to providing “opt in” and “opt out” options, the present disclosure contemplates providing notifications relating to the access or use of personal information. For instance, a user may be notified upon downloading an application (“app”) that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of information that may include personal information data to implement one or more various disclosed embodiments, the present disclosure also contemplates that the various embodiments can also be implemented without the need for accessing personal information data. That is, the various embodiments of the present technology are not rendered inoperable due to the lack of all or a portion of such personal information data.

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Computer-generated reality: in contrast, a computer-generated reality (CGR) environment refers to a wholly or partially simulated environment that people sense and/or interact with via an electronic system. In CGR, a subset of a person's physical motions, or representations thereof, are tracked, and, in response, one or more characteristics of one or more virtual objects simulated in the CGR environment are adjusted in a manner that comports with at least one law of physics. For example, a CGR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a CGR environment may be made in response to representations of physical motions (e.g., vocal commands). A person may sense and/or interact with a CGR object using any one of their senses, including sight, sound, touch, taste, and smell. For example, a person may sense and/or interact with audio objects that create 3D or spatial audio environment that provides the perception of point audio sources in 3D space. In another example, audio objects may enable audio transparency, which selectively incorporates ambient sounds from the physical environment with or without computer-generated audio. In some CGR environments, a person may sense and/or interact only with audio objects. Examples of CGR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground. Examples of mixed realities include augmented reality and augmented virtuality. Augmented reality: an augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof. Augmented virtuality: an augmented virtuality (AV) environment refers to a simulated environment in which a virtual or computer generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

Hardware: there are many different types of electronic systems that enable a person to sense and/or interact with various CGR environments. Examples include head mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mounted system may have one or more speaker(s) and an integrated opaque display. Alternatively, a head mounted system may be configured to accept an external opaque display (e.g., a smartphone). The head mounted system may incorporate one or more imaging sensors to capture images or video of the physical environment, and/or one or more microphones to capture audio of the physical environment. Rather than an opaque display, a head mounted system may have a transparent or translucent display. The transparent or translucent display may have a medium through which light representative of images is directed to a person's eyes. The display may utilize digital light projection, OLEDs, LEDs, μLEDs, liquid crystal on silicon, laser scanning light sources, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

The foregoing is merely illustrative and various modifications can be made to the described embodiments. The foregoing embodiments may be implemented individually or in any combination.

What is claimed is:

1. A headband operable with a head-mounted device having a head-mounted housing member, the headband comprising:
a first headband portion configured to be coupled to the head-mounted housing member;
a second headband portion that extends from the first headband portion at a fixed angle; and
stiffeners in the first and second headband portions.

2. The headband of claim 1, wherein the first and second headband portions comprise a strap having a cavity, and wherein the stiffeners are formed within the cavity.

3. The headband of claim 2, wherein the strap comprises a woven fabric portion surrounded by a webbing, and wherein the webbing has rounded corners at an edge of the woven fabric portion.

4. The headband of claim 3, wherein the webbing has a first portion and a second portion, and wherein the first and second portions of the webbing meet at a seam that is invisible to a naked eye.

5. The headband of claim 4, wherein the seam is a single seam on only one side of the strap.

6. The headband of claim 2, wherein the first headband portion has a first edge and an opposing second edge, the second headband portion has a third edge and an opposing fourth edge, and the stiffeners include a first stiffener along the second edge and a second stiffener along the third edge.

7. The headband of claim 6, wherein the second edge is a lower edge of the first headband portion, and the third edge is an upper edge of the second headband portion.

8. The headband of claim 7, wherein the first stiffener extends across an entirety of the second edge, and the second stiffener extends across an entirety of the third edge.

9. The headband of claim 7, wherein the first stiffener extends partially across the second edge, and the second stiffener extends partially across the third edge.

10. The headband of claim 2, wherein the headband is configured to be straight when not under tension and is configured to conform to a compound curved surface when under tension.

11. The headband of claim 2, wherein the stiffeners comprise braided cords.

12. The headband of claim 1, further comprising:
a surface, wherein the stiffeners are formed on the surface.

13. The headband of claim 12, wherein the stiffeners comprise stiffener material added to the surface.

14. The headband of claim 12, wherein first portions of the surface are removed, and the stiffeners comprise second portions of the surface that have not been removed.

15. A head-mounted device headband operable with a head-mounted device housing, comprising:
a first end configured to couple to a first side of the head-mounted device housing;
a second end configured to couple to an opposing second side of the head-mounted device housing;
a first headband portion that extends between the first end and the second end;
a second headband portion that extends between the first end and the second end;
a first stiffener embedded in the first headband portion; and
a second stiffener embedded in the second headband portion.

16. The head-mounted device headband of claim 15, wherein the first and second stiffeners comprise braided cords.

17. The head-mounted device headband of claim 16, wherein the first and second stiffeners extend entirely across respective edges of the first and second headband portions.

18. The head-mounted device headband of claim 15, wherein the first end comprises a pivot, the first headband portion is configured to couple to the pivot, and the first headband portion is configured to be adjusted relative to the second headband portion as the first headband portion rotates about the pivot.

19. The head-mounted device headband of claim 18, wherein the pivot is a first pivot, the first end comprises a second pivot, and the second headband portion is configured to couple to the second pivot.

20. The head-mounted device headband of claim 19, wherein the second end comprises third and fourth pivots, the first headband portion is configured to couple to the third pivot, and the second headband portion is configured to couple to the fourth pivot.

21. A head-mounted device support structure configured to couple to a head-mounted device housing, the head-mounted device support structure comprising:
a headband comprising first and second bifurcated headband portions;
a ring through which the headband extends, wherein the first and second bifurcated headband portions are separated by the ring; and
stiffeners on a surface of the headband in the first and second bifurcated headband portions.

22. The head-mounted device support structure of claim 21, wherein the stiffeners are configured to pass through the ring when the headband is adjusted.

23. The head-mounted device support structure of claim 22, further comprising:
first and second braided cables respectively embedded in the first and second bifurcated headband portions.

24. The head-mounted device support structure of claim 21, further comprising:
first and second adjustment loops, wherein the first and second bifurcated headband portions comprise double-backed portions that respectively pass through the first and second adjustment loops.

25. The head-mounted device support structure of claim 24, further comprising:
first and second soft keeper loops, wherein the double-backed portions of the first and second bifurcated headband portions are respectively configured to pass through the first and second soft keeper loops.

26. The head-mounted device support structure of claim 21, wherein the ring is a curved ring.

27. The head-mounted device support structure of claim 21, wherein the ring is formed in a carrier, the carrier comprises a loop, and the carrier separates the first and second bifurcated headband portions.

28. The head-mounted device support structure of claim 27, wherein the carrier comprises an additional loop, and the headband is configured to pass through the loop, the ring, and the additional loop of the carrier.
